(19) United States
(12) Patent Application Publication
(10) Pub. No.: US 2008/0212813 A1
(43) Pub. Date: Sep. 4, 2008

(54) Snap-on fastening device for hearing device

(76) Inventors: Holger Kral, Furth (DE); Stefanie Preusche, Erlangen (DE); Joseph Sauer, Strullendorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/072,846

(22) Filed: Feb. 28, 2008

(30) Foreign Application Priority Data
Mar. 1, 2007 (DE) 10 2007 010 011.8

(51) Int. Cl. H04R 25/00

(52) U.S. Cl. 381/312

(57) ABSTRACT

With housing elements of a hearing device which are fastened to a frame for accommodating internal components of the hearing device, the use of a large number of additional parts is problematic because of the risk of losing parts. In accordance with the invention a snap-on fastening means is used to fasten a housing element to the frame of the hearing device, with an opening being provided in the housing element and the frame for accommodating the snap-on fastening means.

### CROSS REFERENCE TO RELATED APPLICATIONS

This application claims priority of German application No. 10 2007 010 011.8 filed Mar. 1, 2007, which is incorporated by reference herein in its entirety.

### FIELD OF THE INVENTION

The invention relates to a snap-on fastening device of a hearing device.

### BACKGROUND OF THE INVENTION

With housing elements (shells) of a hearing device which are fastened to a frame for accommodating internal components of the hearing device, the use of large numbers of additional parts is problematic because of the risk of losing parts.

Housing fastenings on the frame by a number of snap-on connections cannot be used for reasons of size dimensioning.

The complex frame must be fixed in the hearing device housing and also be able to be easily and quickly released when the housing (shell) is changed.

Previously the frame has been supported directly in one housing shell with the shells then being screwed together. Another solution is to use pins which are pushed through the frame and the housing.

### SUMMARY OF THE INVENTION

With housing elements of a hearing device which are fastened to a frame for accommodating internal components of the hearing device, the use of a large number of additional parts is problematic because of the risk of losing parts. The object of the invention is therefore to provide a snap-on fastening means that is used to fasten a housing element to the frame of the hearing device, with an opening being provided in the housing element and the frame for accommodating the snap-on fastening means.

### BRIEF DESCRIPTION OF THE DRAWINGS

The invention is also shown in the form of a drawing comprising three figures.

FIG. 1 shows a cross-sectional diagram of the hearing device without the electrical components, i.e. a housing element GH, a frame FR and a snap-on fastening element SF in the snapped-on state.

FIG. 2 shows a cross-sectional diagram of the hearing device in detail, with the snap-on fastening SF in the snapped-on state.

FIG. 3 shows a cross-sectional diagram of the hearing device in detail, with the snap-on fastening element SF shown removed from the snap-on opening.

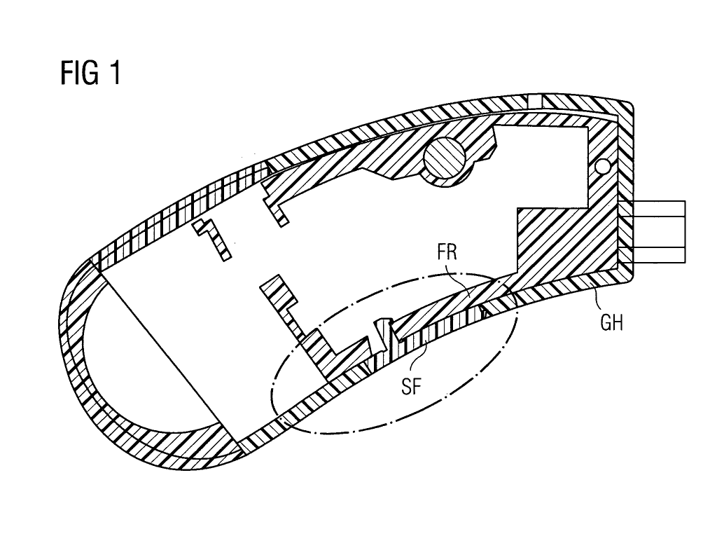

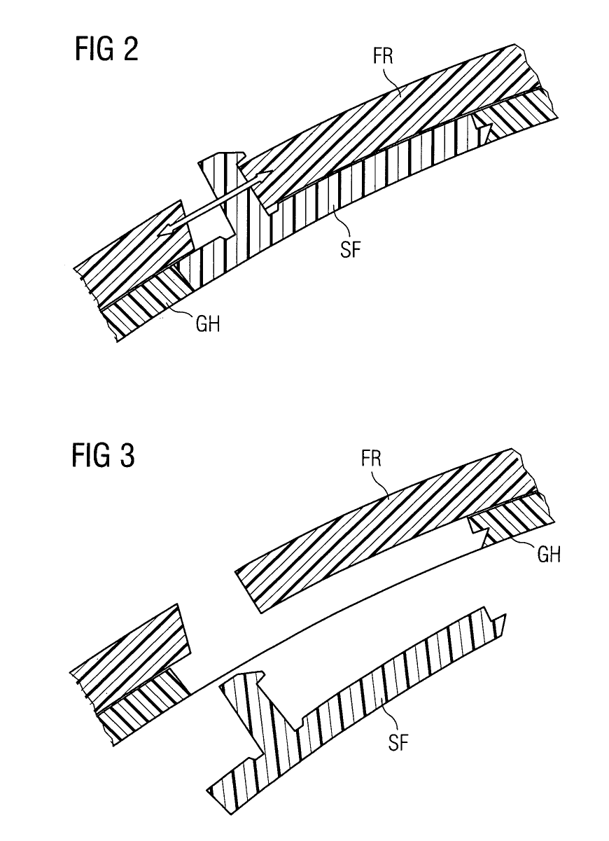

### DETAILED DESCRIPTION OF THE INVENTION

In accordance with the invention a snap-on fastening means for fastening a housing element (shell) to the frame of the hearing device is used, with an opening being provided in the housing element and the frame for accommodating the snap-on fastening means, and with the snap-on spring of the snap-on fastening means being embodied so as to reach through the opening of the housing element and of the frame and to snap onto the frame, which simultaneously fixes the frame.

The advantage of the invention is that no pins or screws which disturb the design are used on the housing and that no size problems arise.

In a variant of the invention the snap-on fastening means is simultaneously employed as the type designation plate. That part of the snap-on fastening means SF which is used as the type designation plate locates in the opening in the housing. The result of this is to integrate the type designation plate in the snap-on fastening means.

In a further variant or embodiment of the invention two housing shells can be used which are fitted onto one side (e.g. upper side) of the frame and on the other side (e.g. lower side) are held together by the snap-on fastening means, with the frame being fixed at the same time by the snap-on fastening means.

1.-3. (canceled)

4. A hearing device, comprising:
a frame that accommodates a component of the hearing device;
a housing element that surrounds the frame; and
a snap-on fastening device comprising a snap-on fastening spring that fastens the housing element to the frame by reaching the snap-on fastening spring through an opening of the housing element and an opening of the frame and snapping on the snap-on fastening spring in the frame.

5. The hearing device as claimed in claim 4, wherein the snap-on fastening device is simultaneously used as a type designation plate.

6. The hearing device as claimed in claim 4, wherein the hearing device comprises two housing elements.

7. The hearing device as claimed in claim 6, wherein one of the two housing elements is fitted on an upper side of the frame and another one of the two housing elements is fitted on a lower side of the frame.

8. The hearing device as claimed in claim 7, wherein the two housing elements are held together by the snap-on fastening device.

9. The hearing device as claimed in claim 4, wherein the snap-on fastening device simultaneously fixes the frame by snapping on the snap-on fastening spring in the frame.

10. A method for fastening a housing element to a frame of a hearing device, comprising:
providing a snap-on fastening device comprising a snap-on fastening spring;
passing the snap-on fastening spring through an opening of the housing element and an opening of the frame; and
snapping on the snap-on fastening spring in the frame.

11. The method as claimed in claim 10, wherein the snap-on fastening device simultaneously fixes the frame by snapping on the snap-on fastening spring in the frame.
